(19) United States
(12) Patent Application Publication
(10) Pub. No.: US 2019/0362220 A1
(43) Pub. Date: Nov. 28, 2019

(54) ATTENTIVE NEURAL COLLABORATIVE FILTERING FOR MODELING IMPLICIT FEEDBACK

(71) Applicant: SAP SE, Walldorf (DE)

(72) Inventors: Benjamin Yan Han Yap, Singapore (SG); Qi Chen, Singapore (SG); Azad Mohammed Moosa Akbar, Singapore (SG); Abhijeet Bhanjadeo, Singapore (SG); Pern Piao Calvin Soh, Singapore (SG); Madhur Mayank Sharma, Singapore (SG); Aniket Vasudeo Gadre, Singapore (SG)

(21) Appl. No.: 15/989,350

(22) Filed: May 25, 2018

(51) Int. Cl. G06N 3/04; G06N 3/08; G06N 3/063

(52) U.S. Cl. CPC G06N 3/0445; G06N 3/063; G06N 3/08

(57) ABSTRACT

Methods, systems, and media for providing a user vector including a plurality of user attributes, each user attribute having a value assigned thereto, the user vector being representative of a user, determining a user latent vector by processing the user vector through an attribute embedding look-up, and an attention layer, and for each item in a set of items: providing an item vector including a plurality of item attributes, each item attribute having a value assigned thereto, the item vector being specific to an item in the set of items, determining an item latent vector by processing the item vector through the attribute embedding look-up, and the attention layer, and processing the user and item latent vectors through connected layers to extract higher order features, and learn relationships between the user, and the item, and to provide a user-item score that represents a compatibility between the user and the item.

### BACKGROUND

Recommender systems can be described as computer-implemented information filtering systems that predict the rating, or preference a user would give to content. Recommender systems are implemented in a variety of areas including movies, music, news, books, research articles, search queries, social tags, commercial goods, and services. Some traditional recommender systems have relied on explicit feedback such as user ratings on content (e.g., users rating restaurants, movies, books). Such approaches, however, require users to manually provide feedback, which they may decline. Network-based consumption (e.g., user selection of content from a web page) indicates implicit preferences. However, integrating implicit user feedback into recommender systems can be a challenging, resource-intensive task.

### SUMMARY

Implementations of the present disclosure include computer-implemented methods for modeling implicit feedback from network-based content consumption. More particularly, implementations of the present disclosure are directed to computer-implemented methods for attentive neural collaborative filtering for modeling implicit feedback from network-based content consumption. In some implementations, actions include providing a user vector including a plurality of user attributes, each user attribute having a value assigned thereto, the user vector being representative of a user, determining a user latent vector by processing the user vector through an attribute embedding look-up, and an attention layer, and for each item in a set of items: providing an item vector including a plurality of item attributes, each item attribute having a value assigned thereto, the item vector being specific to an item in the set of items, determining an item latent vector by processing the item vector through the attribute embedding look-up, and the attention layer, and processing the user latent vector, and the item latent vector through multiple fully connected layers to extract higher order features, and learn relationships between the user, and the item, and to provide a user-item score that represents a compatibility between the user and the item. Other implementations of this aspect include corresponding systems, apparatus, and computer programs, configured to perform the actions of the methods, encoded on computer storage devices.

These and other implementations can each optionally include one or more of the following features: processing further includes concatenating the user latent vector, and the item latent vector; actions further include caching a plurality of user latent vectors, and a plurality of item latent vectors; actions further include transferring a plurality of user latent vectors, and a plurality of item latent vectors from random access memory (RAM) to video RAM (VRAM), and storing the plurality of user latent vectors, and item latent vectors as respective matrices; executing a selection algorithm using a graphical processor unit (GPU) to select one or more items from the set of items to recommend to the user; the one or more items are selected based on respective user-item scores; and the attention layer automatically determines weights to be applied to respective user attributes in the user vector, and item attributes in the item vector.

The present disclosure also provides a computer-readable storage medium coupled to one or more processors and having instructions stored thereon which, when executed by the one or more processors, cause the one or more processors to perform operations in accordance with implementations of the methods provided herein.

The present disclosure further provides a system for implementing the methods provided herein. The system includes one or more processors, and a computer-readable storage medium coupled to the one or more processors having instructions stored thereon which, when executed by the one or more processors, cause the one or more processors to perform operations in accordance with implementations of the methods provided herein.

It is appreciated that methods in accordance with the present disclosure can include any combination of the aspects and features described herein. That is, methods in accordance with the present disclosure are not limited to the combinations of aspects and features specifically described herein, but also include any combination of the aspects and features provided.

The details of one or more implementations of the present disclosure are set forth in the accompanying drawings and the description below. Other features and advantages of the present disclosure will be apparent from the description and drawings, and from the claims.

### DESCRIPTION OF DRAWINGS

FIG. 1 depicts an example architecture that can be used to execute implementations of the present disclosure.

FIG. 2 depicts an example conceptual architecture in accordance with implementations of the present disclosure.

FIGS. 3A-3C are graphs depicting performance of the attention-based system of the present disclosure relative to other systems.

FIG. 4 depicts an example process that can be executed in accordance with implementations of the present disclosure.

FIG. 5 is a schematic illustration of example computer systems that can be used to execute implementations of the present disclosure.

Like reference symbols in the various drawings indicate like elements.

### DETAILED DESCRIPTION

Implementations of the present disclosure include computer-implemented methods for modeling implicit feedback from network-based content consumption. More particularly, implementations of the present disclosure are directed to computer-implemented methods for attentive neural collaborative filtering for modeling implicit feedback from network-based content consumption. Implementations can include actions of providing a user vector including a plurality of user attributes, each user attribute having a value assigned thereto, the user vector being representative of a user, determining a user latent vector by processing the user vector through an attribute embedding look-up, and an attention layer, and for each item in a set of items: providing an item vector including a plurality of item attributes, each item attribute having a value assigned thereto, the item vector being specific to an item in the set of items, determining an item latent vector by processing the item vector through the attribute embedding look-up, and the attention layer, and processing the user latent vector, and the item latent vector through multiple fully connected layers to extract higher order features, and learn relationships between the user, and the item, and to provide a user-item score that represents a compatibility between the user and the item.

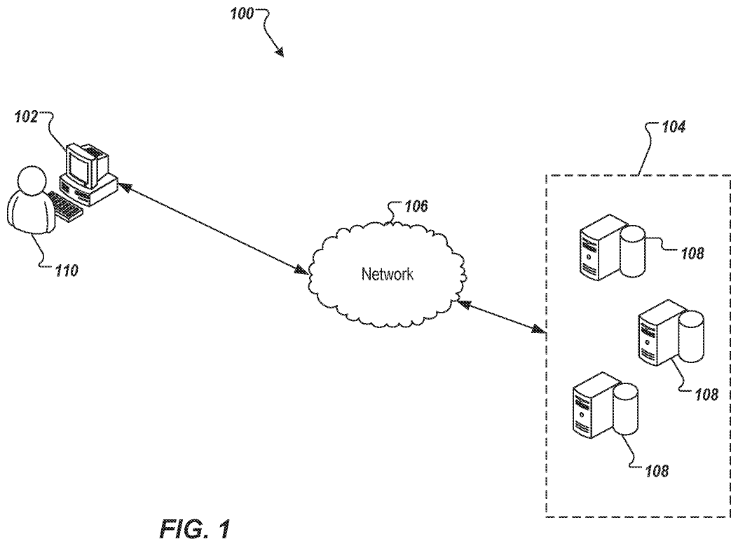

FIG. 1 depicts an example architecture 100 that can be used to execute implementations of the present disclosure. In the depicted example, the example architecture 100 includes one or more client devices 102, a server system 104 and a network 106. The server system 104 includes one or more server devices 108. In the depicted example, a user 110 interacts with the client device 102. In an example context, the user 110 can include a user, who interacts with an application that is hosted by the server system 104.

In some examples, the client device 102 can communicate with one or more of the server devices 108 over the network 106. In some examples, the client device 102 can include any appropriate type of computing device such as a desktop computer, a laptop computer, a handheld computer, a tablet computer, a personal digital assistant (PDA), a cellular telephone, a network appliance, a camera, a smart phone, an enhanced general packet radio service (EGPRS) mobile phone, a media player, a navigation device, an email device, a game console, or an appropriate combination of any two or more of these devices or other data processing devices.

In some implementations, the network 106 can include a large computer network, such as a local area network (LAN), a wide area network (WAN), the Internet, a cellular network, a telephone network (e.g., PSTN) or an appropriate combination thereof connecting any number of communication devices, mobile computing devices, fixed computing devices and server systems.

In some implementations, each server device 108 includes at least one server and at least one data store. In the example of FIG. 1, the server devices 108 are intended to represent various forms of servers including, but not limited to a web server, an application server, a proxy server, a network server, and/or a server pool. In general, server systems accept requests for application services and provides such services to any number of client devices (e.g., the client device 102) over the network 106.

In accordance with implementations of the present disclosure, the server system 104 can host a recommender service (e.g., provided as one or more computer-executable programs executed by one or more computing devices). For example, a recommender service can be hosted on the server system 104, and can provide one or more recommended items to a user 110 based on an attention-based neural collaborative filtering (NCF) model of the present disclosure. In some examples, and as described in further detail herein, a user profile can be provided for the user 110, which includes one or more user attributes to provide a representation of the user 110. As item vector is provided for each item of a plurality of items that could be recommended to the user 110. In some examples, the item vector includes one or more item attributes to provide a representation of the respective item. The user vector and the item vector are provided as input to the attention-based NCF of the present disclosure, which provides a user latent vector, and an item latent vector, respectively, that are combined and processed to provide a score. In some examples, the score represents a relevance of the particular item to the user 110.

To provide context for implementations of the present disclosure, the consumption of network-based content (e.g., Internet content), as well as the amount of content freely available on networks (e.g., the Internet), have been consistently increasing over the years. The overabundance of online content for users to consume poses a challenge to the average user in discerning what content the user should prioritize for consumption. Recommender systems aim to address this need by automatically ranking all available content for a user based on their preferences, profile, and/or content viewed in the past. Based on this information, a recommender system can return ranked items to the user enabling the user to efficiently consume the content.

Recommender systems have been widely adopted by many online content providers to recommend, among other content, videos, music, news articles, books, products, services, and educational courses. Popular methods used for recommender systems include matrix factorization (MF), item or user-based collaborative filtering, or a combination thereof. Such recommender systems have also relied on explicit feedback such as user ratings on items. These approaches, however, require users to manually provide feedback, which they may decline. Consequently, traditional recommender systems may be incomplete, and inefficient in executing their functionality.

In further detail, traditional recommender systems have strongly relied on collaborative filtering (CF) to model past user interactions with items, and MF is a commonly used technique to perform collaborative filtering. In MF, a user-item matrix is decomposed to separate matrices containing latent user, and item representations. Work has been done to improve upon the MF approach, such as integrating it with nearest-neighbor model, combining it with topic modeling, and using weighted updates to optimize the latent representations. User- or item-based CF can also be performed independently of one another. Given some metadata about a user or item (e.g., user or item attributes), a feature vector representing a single user or item can be constructed. Several similarity measures (e.g., cosine similarity, Euclidean distance) can be applied to the vectors to find similar users or items. Further, a weighted loss function for CF on implicit feedback datasets has been proposed, where the training data only consists of whether a user has viewed an item (e.g., a view of an item being implicit feedback), but not explicitly rated the item.

Deep learning-based recommender systems have recently gained traction due to their strong performance. For example, a convolutional neural network (CNN) has been used to extract contextual cues from documents to improve the performance of recommender systems. Stacked de-noising auto-encoders have also been used to clean noisy input for CF. An end-to-end neural CF approach has also been used to tackle implicit feedback datasets. Like CF, this approach maps each user and item to a unique vector, and concatenates both vectors to be input into a multilayer feed forward neural network. The purpose of the neural network is to learn deep representations of the user-item pair to predict a compatibility score for them. This model is trained end-to-end using gradient descent algorithms.

Recurrent neural network (RNN) architectures have also been used to generate recommendations for videos and products, and model educational content. Items viewed by the user are sorted by chronological order and fed into RNN, or a long short-term memory network (LSTM). The network sequentially encodes these items into a continuous vector, and uses the vector to predict the next item that the user is recommended to view. One benefit of recent deep learning approaches is that models can be trained in an online manner. When new interactions between the user and an item occurs, that interaction can be learned by the model without re-training the model from scratch.

In view of the foregoing, implementations of the present disclosure recognize that modern, network-driven content consumption makes it easy to track content viewership (consumption). This provides a large amount of implicit feedback that can be used to train a recommender system using deep learning, which has enabled great progress in other fields (e.g., computer vision, natural language processing, and speech processing). Implementations of the present disclosure apply deep learning to train recommender systems based on implicit feedback in network-based content consumption. More particularly, and as described in further detail herein, implementations of the present disclosure provide a neural attention model for recommender systems on implicit feedback datasets. The neural attention model is referred to herein as an attention-based neural collaborative filtering (NCF) model. Implementations of the present disclosure leverage the fact that a neural network is able to act as a universal approximator to approximate any continuous function, and is therefore capable of learning a function ƒ(u,i) to calculate the compatibility of a user profile u to item profile i.

In accordance with implementations of the present disclosure, the attention-based NCF model of the present disclosure incorporates user and item metadata (e.g., user attributes and item attributes) during training and inference. This induces a similar vector space representation for similar users (items). An attention layer automatically learns the importance of each user attribute, and each item attribute. The attention layer performs respective weighted combinations to obtain a user representation, and an item representation. In further detail, the attention layer automatically re-weights user/item metadata based on an implicitly learned importance factor.

Further, the attention-based NCF model reduces the impact of data sparsity by explicitly modeling user and item profiles, and invariably resolves the cold-start problem (e.g., lack of data at the outset) that traditional CF systems struggle with. Further, and as compared to other CF systems, the attention-based NCF model of the present disclosure requires only a fixed memory size regardless of the number of users and items. The attention-based NCF model also provides a level of traceability of the importance of factors considered when items are recommended. Accordingly, the attention-based NCF model of the present disclosure provides a multitude of technical improvements over traditional recommender systems. Example technical improvements include, without limitation, reducing data sparsity, addressing cold-start, and reduced memory footprint.

Implementations of the present disclosure are described in further detail herein with reference to an example context. The example context includes recommending online content, such as e-learning courses (items), to a user (e.g., an employee of an enterprise). However, implementations of the present disclosure can be generalized, and can be applied to recommending any appropriate type of content (e.g., products, goods).

As described in further detail herein, in the attentive NCF architecture of the present disclosure, each user attribute corresponds to a single vector in a user matrix, and each item attribute corresponds to a single vector in an item matrix. A lookup operation obtains the vectors, and the attention layer automatically calculates the weighted combination of the vectors to form a single vector representing the user, and a single vector representing the item, respectively. The user vector, and the item vector are input into multiple fully connected feed forward layers before the final output layer predicts a single scalar value as the compatibility score between the user and the item.

Traditional CF calculates an inner product of the user latent vector and item latent vector in order to estimate the compatibility score of each user-item pair (u,i). As opposed to traditional CF, NCF replaces the inner product with a neural architecture that learns a function that could estimate the compatibility score from the data itself. This data-driven approach is more powerful in terms of model capacity.

The input of NCF is a unique identifier assigned to a user (user identifier), and a unique identifier assigned to an item (item identifier), each encoded as a one-hot vector. For each user and item, the model maps the identity of the user and the item to respective vectors, each of which is a latent vector in the context of a latent factor model. The user vector and item vector are concatenated, and fed into a multi-layer feed forward neural architecture. The final output of NCF layers is a prediction score that estimates the compatibility between the given user and item. NCF is designed for implicit feedback datasets, where the ground truth compatibility score for one user-item pair are binary (e.g., a score of 1 means that there is an interaction between a user and an item, and a score of 0 means that a user has not interacted with an item). As such, it makes sense that NCF treats compatibility score prediction as a binary classification problem. The output prediction score of NCF is constrained in the range of [0,1] by using a probabilistic function.

The attentive NCF architecture of the present disclosure resolves the cold-start issue, reduces the sparsity of training data, and enables the attention-based NCF model to be scalable and have a fixed memory size independent of the number of users and items. The attention layer of the attention-based NCF model provides multiple benefits. For example, the attention layer re-weights user attributes, and item attributes considered by the model by an automatically learned scale factor. Intuitively, humans do not consider all factors as equally important when giving recommendations. This is emulated by the attention layer. As another example, the automatically learned attention weights provides traceability as to which attributes are important and focused on during recommendation. The attention-based NCF model is trained end-to-end without the need for explicitly providing the importance weights for the attention layer.

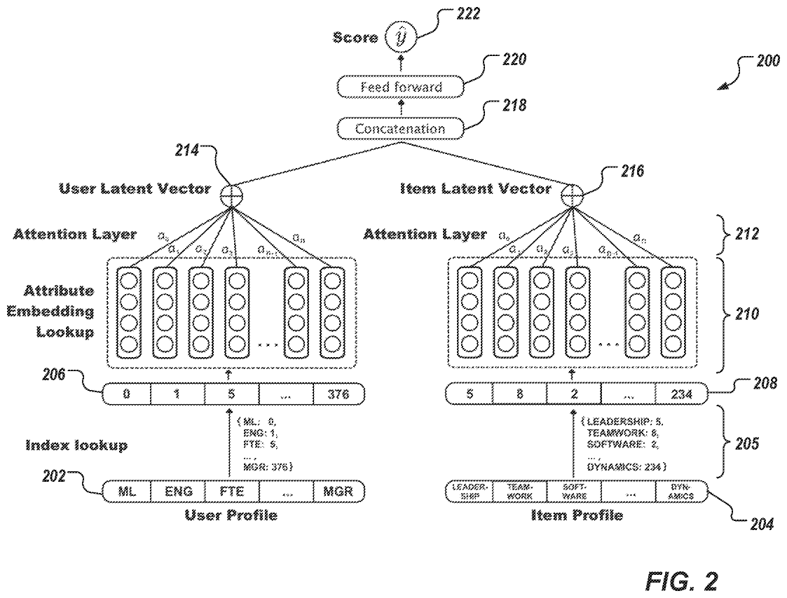

FIG. 2 depicts an example conceptual architecture 200 in accordance with implementations of the present disclosure. The example conceptual architecture 200 includes a user profile 202, and an item profile 204, an index lookup 205, a user vector 206, an item vector 208, an attribute embedding lookup 210, a user latent vector 214, an item latent vector 216, a concatenation 218, a feed forward neural network 220, and a score 222. As described in further detail herein, implementations of the present disclosure determine the score 222 (provided as a scalar value) for a respective user-item pair. In some examples, the score 222 represents a compatibility of the user and the item in the user-item pair.

In some implementations, the user profile 202 provides a list of user attributes for a particular user (e.g., based on a user-specific identifier), and the item profile 204 provides a list of item attributes for a particular item (e.g., based on a item-specific identifier). In some implementations, the index lookup 205 is performed to provide respective values for each attribute resulting in the user vector 206, and the item vector 208, respectively. As described in further detail herein, the user vector 206, and the item vector 208 are processed through the attribute embedding lookup 210, and attention layer 212 to provide the user latent vector 214, and the item layer vector 216, respectively. The user latent vector 214, and the item layer vector 216 are concatenated through the concatenation 218, and are processed through the feed forward neural network 220 to provide the score 222.

In accordance with implementations of the present disclosure, each user and each item is represented with a list of user attributes, and item attributes, respectively (e.g., the user vector 206, and the item vector 208 of FIG. 2). An attribute set D is provided, which records the attributes for users and items. Each attribute is represented by a unique index in the range of [0, |D|−1]. A lookup table (LT∈ [symbol] ^{k×|D|}) stores the vectors (each of dimension k) corresponding to each attribute, which are parameters to be learned. For a user-item pair, the input to the attention-based NCF model contains a list of user attributes, and a list of item attributes (e.g., the user vector 206, and the item vector 208 of FIG. 2). On top of the input layer, an attribute embedding lookup operation (e.g., the attribute embedding lookup 210 of FIG. 2) retrieves the vector for each attribute, resulting in a k×M user matrix (Eᵤ), and a k×N item matrix (Eᵢ). M represents the number of attributes a particular user has, and N represents the number of attributes an item has. An attention mechanism (e.g., the attention layer 212 of FIG. 2) constructs a user vector representation (zᵤ), and an item vector representation (zᵢ). Both zᵤ and zᵢ are weighted sums over Eᵤ and Eᵢ, respectively. The user vector, and the item vector can be respectively defined as follows:

zᵤ=Σₘ^{M}aᵤ_{ₘ}eᵤ_{ₘ} (1)

zᵢ=Σₙ^{N}aᵢ_{ₙ}eᵢ_{ₙ} (2)

where aᵤ_{ₘ} and aᵢ_{ₙ} are the attention weights for each attribute for the user, and item, respectively, and eᵤ_{ₘ} and eᵢ_{ₙ} are the vectors for each attribute of the user and item, respectively. The attention weights are calculated in a similar way for both the user and the item. For brevity, only the calculation of the attention weights for the user are provided herein as:

$$\begin{matrix}{a}_{{u}_{m}} = \frac{exp ( {d}_{{u}_{m}} )}{{\sum }_{j}^{M} exp ( {d}_{{u}_{j}} )} \\ where & ( 3 ) \\ {d}_{{u}_{m}} = {e}_{{u}_{m}}^{ú} \cdot {W}_{u} \cdot {y}_{u} \\ where & ( 4 ) \\ {y}_{u} = \frac{1}{M} {\sum }_{m}^{M} {e}_{{u}_{m}} & ( 5 )\end{matrix}$$

and where yᵤ is the mean of all input attribute vectors, which captures the context information of the input. The vector is transformed with a mapping matrix (Wᵤ∈ [symbol] ^{k×k}) which contains trainable parameters. The resulting vector is used to calculate a scalar dᵤ_{ₘ} for each user attribute using a dot product with each user attribute eᵤ_{ₘ}. The final attention weights for each attribute are provided using a softmax operation over all scalars d_{0 . . . M-1}. Similar to users, a matrix (Wᵢ∈ [symbol] ^{k×k}) is provided for items.

The resultant user and item vectors zᵤ and zᵢ (e.g., the user latent vector 214, and the item latent vector 216 of FIG. 2), respectively, are concatenated and fed into multiple fully connected layers. In some implementations, the calculations for the first hidden layer, and the calculations for the subsequent hidden layers are respectively provided as follows:

$$\begin{matrix}{h}_{0} = σ ( {W}_{0} [ \begin{matrix}{Z}_{i} \\ {Z}_{u}\end{matrix} ] + {b}_{0} ) \\ and & ( 6 ) \\ {h}_{t} = σ ( {W}_{t} {h}_{t - 1} + {b}_{t} ) & ( 7 )\end{matrix}$$

where W₀∈ [symbol] ^{k×2k} is a matrix with trainable parameters mapping the concatenated user vector, and item vector to a single k-dimensional representation. Subsequently, T fully connected feed forward layers (hₜ), with trainable weights (Wₜ∈ [symbol] ^{k×k}), can be added to learn deeper interactions between the user and the item. In some examples, bₜ∈ [symbol] ^{k} represents the bias of each hidden layer, and a represents an activation function to induce non-linearity in the multiple hidden layers. In some implementations, a sigmoid function is used. However, it is contemplated that any other appropriate activation function can be used (e.g., tanh, ReLU).

The multiple fully connected layers extract higher order features and learn relationships between the user and item. In an example experiment, k=50 and T=6 for a good balance between model performance, training/inference speed, and memory requirements. In some examples, it has been shown that choosing larger values of k and T does increase model performance at the expense of training/inference time. The final hidden layer is connected to an output layer with a single neuron and a sigmoid activation function which outputs the compatibility score between the user and the item, in the range of [0,1].

The output of the attention-based NCF model of the present disclosure is a scalar value (\hat{γ}∈[0,1]) (e.g., the score 222 of FIG. 2), which is constrained to a value within that range by the sigmoid function. The log loss (L) of the model is minimized during training, as represented below:

$$L = - \frac{1}{N} {\sum }_{i = 1}^{N} y log \hat{y} + ( 1 - y ) log ( 1 - \hat{y} ) \qquad ( 8 )$$

where y is the ground truth value, and N is the number of training instances. In some examples, the attention-based NCF model is trained end-to-end using gradient descent, and the learning rate is dynamically adapted for faster convergence. In some examples, the inputs and the outputs of the model are fed in mini-batches for training.

As introduced above, in traditional CF approaches, each user and item is represented by a single k-dimensional vector. This approach scales linearly with the number of users or items. For example, let Ube the number of users and I be the number of items. Therefore, to represent users and items U×k+I×k floating point numbers must be stored. For the attention-based NCF model of the present disclosure, however, each user attribute and item attribute is stored as a k-dimensional vector. In total, only Aᵤ×k+Aᵢ×k floating point numbers are stored, where Aᵤ is the number of user attributes, and Aᵢ is the number of item attributes. In most cases, Aᵤ<<U and Aᵢ<<1. Consequently, and as compared to traditional CF approaches, the attention-based NCF model of the present disclosure requires less memory.

Further, implementations of the present disclosure use a weighted sum over user attributes, and item attributes to respectively represent users, and items. In this manner, implementations of the present disclosure reduce data sparsity, as compared to traditional approaches that use, for example, a randomly initialized vector. That is, data sparsity is reduced by explicitly inducing users and items with similar attributes to have similar vectors (due to the weighted sum) compared to users and items with different attributes. Also, implementations of the present disclosure circumvent the cold-start issue by using user attributes, and item attributes, where a new user, and/or a new item is input into the system and does not have a trained corresponding vector. In the attention-based NCF model of the present disclosure, even when a new user, and/or new item is added, a user vector, and/or item vector can be constructed based on the weighted sum over its attributes.

In accordance with implementations of the present disclosure, the additional attention layer enables the attention-based NCF model to dynamically weight attributes, giving a higher weight to attributes which are indicative of whether an item should have a high score. For example, when recommending content to a user, a user's topic of interest and age can be more indicative of the content that we should recommend compared to an attribute such as user name. The attention-based NCF model of the present disclosure inherently learns these weights during training, and does not require explicit supervision. During inference, the weights can be used to trace the attributes that the model learns are important.

Implementations of the present disclosure further include optimizations that provide addition technical improvements of the attentive-based NCF model (e.g., increasing processing speed by over two magnitudes). In a practical scenario, given U users and I items to recommend, U×I inference steps need be run to obtain the compatibility score between each user, and each item before retrieving the top items for each user. The time taken for the entire inference process will therefore be large for many users and items. This time can be significantly decreased using optimizations provided herein. In discussing the optimizations, the attention-based NCF model of FIG. 2 can be considered as three modular components: user latent vector generation; item latent vector generation; and score calculation. Both user latent vector generation, and item latent vector generation encompass Equations 1 to 5 above, and score calculation encompasses Equations 6 and 7 above. In an un-optimized scenario, all three modular components will all be run U×I times.

A first optimization includes caching user latent vectors, and/or item latent vectors. During the inference step, user latent vector generation is run U times to generate the latent user vector for each user, and the item latent vector generation is run I times to generate the latent item vector for each item. The latent vectors are cached in memory to be used in the score calculation. As a result, the number of times user latent vector generation has to be run is decreased by I times, and the number of times item latent vector generation has to be run is decreased by U times. This results in significantly faster inference times.

With regard to a second optimization, modern deep learning models are commonly run on powerful graphical processor units (GPUs). Similarly, the attention-based NCF model of the present disclosure can be executed using one or more GPUs. However, in view of the first optimization described above, cached user latent vectors, and item latent vectors are stored in memory (e.g., random access memory (RAM)). When using a GPU, the cached vectors are transferred to graphics card memory (e.g., video RAM (VRAM)) for score calculation, which takes in a k-dimensional user latent vector, and a k-dimensional item latent vector. To provide recommendations for a single user, 2×I×k floating point values would be input into the score calculation, where the user latent vector has to be duplicated by I times. This I/O data transfer becomes a bottleneck in the inference process.

To resolve this, the second optimization includes transferring the user latent vectors, and the item latent vectors from RAM or VRAM only once during initialization, and store them in the VRAM as matrices with dimensions of U×k (for user latent vectors), and I×k (for item latent vectors). During inference, only an integer index is passed, referencing a particular user latent vector into the GPU. The model performs the lookup and duplication of the user latent vector within the GPU, which is generally faster and more efficient. This optimization reduces CPU to GPU I/O from 2×I×k floating point values to a single integer. In addition, without this I/O bottleneck, inference can be performed for multiple users in parallel in the GPU.

With regard to a third optimization, after the scores for each user-item pair have been computed, a selection algorithm is used to select the highest-scoring items for each user. Traditionally, this process is performed on the CPU. For the attention-based NCF model of the present disclosure, the more efficient GPU can be leveraged for sorting by performing selection directly in the GPU. This optimization not only results in a faster selection, it also decreases the number of output scores from the GPU back to the CPU, further reducing I/O times.

In some implementations, the first, second, and third optimizations described herein can be performed sequentially. Improvements in performance through these optimizations were measured through experiment, and are detailed in the following table:

TABLE 1
Inference time to recommend top 50 e-learning items
out of 120,000 e-learning items for a single user.

| Attention-Based NCF Model Type | Inference Time (ms) |
|---|---|
| Non-optimized | 3000 |
| First Optimization | 1500 |
| Second Optimization | 40.6 |
| Third Optimization | 5.1 |

Experiments were performed to evaluate the attention-based NCF model of the present disclosure relative to other systems. The attention-based NCF model of the present disclosure was evaluated against other models using multiple evaluation metrics (e.g., each being referred to generally as an evaluated model). The experiments were based on the example context described herein (e.g., recommending online training courses (items) to users (employees)).

The experiments were based on three large-scale, real-world datasets. In some examples, the sources of the datasets, as well as data within the datasets, is anonymized. The data sets include a user profile table, a course profile table, and a learning history table. In some examples, the user profile table stores multiple attributes about each user (e.g., user identifier, work domain, job position, full time/part time). The values of the user attributes are tokenized, and used as input to each evaluated model. In some examples, the course profile table stores attributes for each course (e.g., course identifier, course type (mandatory, non-mandatory), course title, course description). In some examples, values of the item attributes are tokenized such that each token is an attribute to the respective course, and used as input to each evaluated model. In some examples, the learning history table stores, for each user in the user profile table, courses that the respective user has taken, as well as the timestamp (e.g., when the user took the course). In some examples, each row includes user identifier, course identifier, and the timestamp that this course has been taken by the respective user. Statistical information about the experimental datasets are shown in Table 2 below.

TABLE 2
Experimental Dataset Statistics

| | Dataset 1 | Dataset 2 | Dataset 3 |
|---|---|---|---|
| #Total Users | 450,000 | 620,000 | 430,000 |
| #Total Courses | 60,000 | 37,000 | 8,700 |
| #Learning | 610,000 | 1,070,000 | 3,444,000 |
| History | | | |
| Data Sparsity | 99.998% | 99.995% | 99.908% |

Because the timestamps of learning history are recorded, the task of the experiments is to recommend the next course that a user is likely to take, given a list of courses that the user has taken before. The dataset train/test split is done based on the timestamps. For example, for each user, the latest course that the user has taken is determined, and is attempted to be recommended during testing. All other courses appearing in the user's learning history are used for training. This is a known strategy, which is referred to as leave-one-out evaluation.

While the learning history is directly input to the attention-based NCF model as positive data during training, negative data is generated based on learning history as well. For each user, a subset of courses that this user has not taken is randomly sampled, and is used as negative data. In the performed experiments, a 1:10 positive to negative ratio was implemented. In some examples, the sampling is performed for each epoch to ensure that the negative data is not fixed across epochs. Further, the implemented negative sampling strategy increases the variety of negative instances, which the evaluated model of the present disclosure is trained on (as opposed to a pre-sampled, fixed set of negative instances).

Example evaluation metrics that were implemented include hit-ratio (HR), normalized discounted cumulative gain (NDCG), and median rank of the ground truth item for all users. With regard to HR and NDCG, instead of sampling negative instances (where the user has not interacted with the item before) for testing, the full set of items is used as candidates for recommendation during testing. This is to simulate a real-world scenario, in which all items have to be considered for the user, instead of a random subset. For each user, each evaluated model calculates the compatibility score of each item for all items. The scores are used to rank the items. The HR is the number of times the ground truth item from the test set is ranked within the top k in the recommended items for a particular user. The NDCG score accounts for the position of the ground truth item within the top k recommendations. A higher NDCG score, and HR score indicates a better performing model. For the experimental evaluation, n=10.

With regard to the median rank metric, this can be seen as complimentary to HR. While HR indicates the proportion of users who would have good recommendations at top k, the median rank enables inferring the value of k for 50% of the users to have at least one good recommendation. For example, if the median rank of 1,000 users is 30, 500 users would have at least one good recommendation in the top 30 recommendations from an evaluated model. Therefore, a lower median rank indicates a better performing model. For the experimental evaluations, 1,000 users were randomly selected from the test set, and their corresponding last course taken.

As described herein, the attention-based NCF model of the present disclosure (also referred to herein as Attentive NCF) was evaluated against multiple baseline models. For the baseline, the size of each user (item) latent vector, k, was set equal to 50. One baseline model included CF, which is designed for implicit feedback, as described herein. In the experiments, an open source CF model, the Fast Python Collaborative Filtering for Implicit Datasets published by Ben Fredrickson, was used. Another baseline model included a base NCF model published by He et al. As described above, the input of the base NCF model includes user identifier, and item identifier. For this baseline model, MLP was used for the evaluation, instead of the joint GMF-MLP. Another baseline model included the base NCF model with user attributes, and item attributes as input, referred to herein as the NCF-Attribute model, which can be described as an attribute-based NCF model without the attention layer. For this, respective latent vectors for user attributes, and item attributes is learned during training. The user vector and item vector is defined as:

zᵤ=Σₘ^{M}eᵤ_{ₘ} (9)

zᵢ=Σₙ^{N}eᵢ_{ₙ} (10)

where eᵤ_{ₘ} and eᵢ_{ₙ} are the vectors for each user attribute, and item attribute, respectively.

Experimental results for the Attentive NCF model of the present disclosure, CF, NCF, and NCF-Attribute are summarized in the following tables:

TABLE 3
Experimental Results on Dataset 1

| | HR@10 | NDCG@10 | Median Rank |
|---|---|---|---|
| CF | 0.168 | 0.104 | 396 |
| NCF | 0.096 | 0.050 | 193 |
| NCF-Attribute | 0.263 | 0.182 | 59 |
| Attentive NCF | 0.361 | 0.236 | 27 |

TABLE 4
Experimental Results on Dataset 2

| | HR@10 | NDCG@10 | Median Rank |
|---|---|---|---|
| CF | 0.286 | 0.141 | 33 |
| NCF | 0.187 | 0.092 | 39 |
| NCF-Attribute | 0.274 | 0.143 | 27 |
| Attentive NCF | 0.349 | 0.180 | 19 |

TABLE 5
Experimental Results on Dataset 3

| | HR@10 | NDCG@10 | Median Rank |
|---|---|---|---|
| CF | 0.273 | 0.138 | 27 |
| NCF | 0.210 | 0.108 | 40.5 |
| NCF-Attribute | 0.347 | 0.196 | 18 |
| Attentive NCF | 0.376 | 0.224 | 15 |

As depicted in the tables, Attentive NCF (i.e., the attention-based NCF model of the present disclosure) outperforms all of the baseline models across all three datasets. Specifically, Attentive NCF works significantly better than CF, NCF, and NCF-Attribute on Dataset 1. For example, the median rank of the three baseline methods are 396, 193 and 59, respectively, and Attentive NCF reduces this number to 27 (a relatively large improvement). With a sparsity of 99.998%, Dataset 1 is the sparsest dataset compared to the other two datasets. This shows that Attentive NCF is able to deal with data with very high sparsity. This is a promising property as it is quite common that modern recommender systems face relatively sparse data. For Dataset 2, the margin between Attentive NCF, and the other baseline approaches is smaller than Dataset 1. For Dataset 3, which has the lowest sparsity (99.908%), the margin decreases further. It also shows that the less sparse the dataset is, the better performance tends to be achieved for all of the models including the Attentive NCF of the present disclosure.

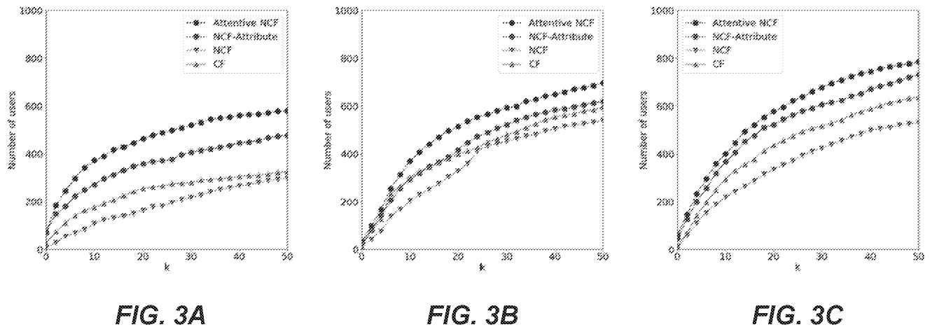

FIGS. 3A-3C are graphs depicting performance of the Attentive NCF model of the present disclosure relative to the baseline models. The graphs of FIGS. 3A-3C are example plots for the number of users (out of 1,000) having at least one good recommendation, based on an actual e-course taken, at top-k recommendations. The example plots show the performance of the Attentive-NCF of the present disclosure relative to three other systems on Dataset 1 (FIG. 3A), Dataset 2 (FIG. 3B), and Dataset 3 (FIG. 3C). FIGS. 3A-3C represent that a relatively high number of users will be satisfied, if the top-k items are recommended, where k varies from 1 to 50. From FIGS. 3A-3C, it can be seen that the gap between the Attentive NCF of the present disclosure, and the second-best approach (NCF-Attribute) becomes larger for a dataset with higher data sparsity. This validates the effectiveness of the attention layer of the attention-based NCF model.

As described herein, and in accordance with implementations of the present disclosure, attention weights are automatically learned by the attention-based NCF model, and show the attributes with the highest weights. This is indicative of the attribute that is focused on when the recommendations are being performed. In further detail, keywords for a sample of the learning courses (items) are provided in the table below:

TABLE 6
Top-5 Keywords from Three Sampled Learning Courses

| Course Description | Keywords |
|---|---|
| css3 specifications include new and | css3, sophisticated, |
| sophisticated options for layout and graphics | become, javascript, |
| however it is crucial to implement responsive | scripting |
| web design which takes account of devices and | |
| browser support for css3 features additionally | |
| you may want to harness scripting languages | |
| such as javascript to manage css3 styles as they | |
| become more complex | |
| personal account opening anti money | money, enhancements, |
| laundering enhancements practice scenarios | laundering, account, |
| retail network | opening |
| this elearning activity is part of the grammar | grammar, elearning, |
| sessions in the writing for service | sessions, activity, |
| | writing |

For each learning course (item), each attribute is sorted based on its attention weights, in this case, the words in the description of the item, and the top 5 words are provided. In this example, the attention layer of the present disclosure rated keywords such as css3, javascript, and scripting relatively highly for a web-based frontend development course, and keywords such as grammar, and elearning relatively highly for a language course. This contributes to the performance of the final model, where less expressive words (e.g., is, it, the) are assigned lower weights.

With regard to cold-start, the item latent vectors provided in accordance with the present disclosure can be clustered within the same vector space to show that similar sentences are clustered into the same cluster. More particularly, to address the cold start problem, a weighted average of attributes can be used to calculate the item latent vector, which is used as input for the feed forward neural network. The intuition behind this is that, even if an item has not been seen before, the weighted average of its attributes will produce an item latent vector that is similar to items with similar attributes that have been seen before. Therefore, the attention-based NCF model is able to provide a relatively good prediction for the new item.

To investigate this, from each dataset, a K-means clustering is performed across all vectors. In some examples, K=100 for the number of clusters, and the item attributes (learning course descriptions) are inspected for each cluster. The following table shows the top-3 courses that are closest to the centroid of its cluster (e.g., based on Euclidean distance):

TABLE 7
Example Clusters and Top-3 Items Closest to Centroid of Clusters

| | |
|---|---|
| 3*Cluster 1 | advanced solutions of microsoft exchange server 2013 |
| | identify the options that provide internet connectivity |
| | within a network infrastructure and the decision criteria |
| | involved in using each one microsoft windows server 2003 |
| | network infrastructure physical design ii internet |
| | connectivity |
| | identify the options that provide remote access on a |
| | network infrastructure and the decision criteria involved in |
| | using each one microsoft windows server 2003 designing |
| | ras services for the network infrastructure |
| *Cluster 2 | linux distribution is made up of a number of utilities and |
| | programs one key utility is the command line shell in this |
| | course you will learn how to use a shell to perform file and |
| | directory manipulation and edit file contents in particular |
| | you will learn about the bourne again shell bash and the vi |
| | text editor |
| | linux installation and configuration is a multi step process |
| | allowing customization based on requirements at almost |
| | every stage in this course you will learn about some of that |
| | customization and some basic patterns of how to do an |
| | initial install you will learn about hard drive partitioning |
| | boot managers software repositories and the tools |
| | necessary to maintain update and install software on |
| | different linux distributions |
| | linux finds a home in every device we would think of as a |
| | computer from smartphones to pcs and data center servers |
| | in this course you will learn about the system architecture |
| | of linux including how it interacts with peripherals and the |
| | boot sequence and how to change the system runlevels and |
| | boot targets |
| *Cluster 3 | to refresh the concepts on exception handling and |
| | multithreading prerequisite basic java target audience all |
| | levels and to know more about the this course visit the |
| | following link training delivery course catalogue doc |
| | course catalogue refresher java exception and |
| | multithreading |
| | to refresh the knowledge on servlets jdbc and jsp |
| | prerequisite core java target audience all levels and to |
| | know more about the this course visit the following link |
| | training delivery course catalogue doc course catalogue |
| | refresher java servlets and jsp |
| | to refresh the knowledge on garbage collection and jvm |
| | prequisite basic java target audience all levels and to know |
| | more about the this course visit the following link training |
| | delivery course catalogue doc course catalogue refresher |
| | java garbage collection reflection and jvm |

From Table 7, it can be inferred that: Cluster 1 contains descriptions of mostly computer server operation systems, and hardware courses; Cluster 2 contains descriptions of courses about operating Linux systems; and Cluster 3 mainly contains Java related courses. These example clusters show that similar courses indeed contain similar vector representations. In this manner, implementations of the present disclosure are able to model new items (e.g., unseen courses). For example, if a new course about Linux systems arrives, the attention layer will produce a representation for that new course, which is similar to other Linux courses (and not computer server or Java courses). When this representation is fed into the feed forward neural network, a relatively accurate prediction can be achieved.

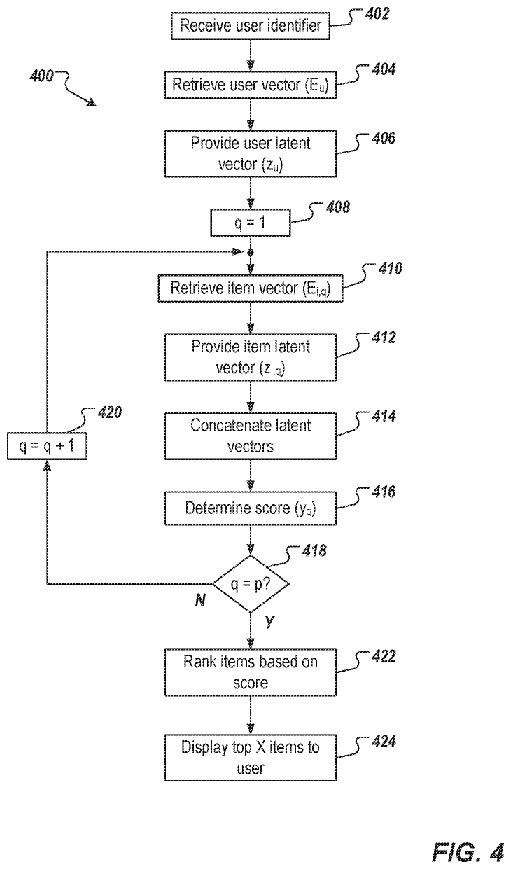

FIG. 4 depicts an example process 400 that can be executed in accordance with implementations of the present disclosure. In some examples, the example process 400 can be provided by one or more computer-executable programs executed using one or more computing devices.

A user identifier is received (402). For example, a recommender system (e.g., hosted on the server system 104 of FIG. 1) can receive a user identifier that is unique to a user (e.g., the user 110 of FIG. 1). A user vector (Eᵤ) is retrieved (404). For example, the recommender system performs an index look-up (e.g., the index look-up 205 of FIG. 2) based on the user identifier to retrieve the user vector for the particular user. In some examples, and as described herein, the user vector includes a set of attributes, each attribute having a respective value assigned thereto. The user vector provides a representation of the user with respect to a particular domain (e.g., e-learning courses).

A user latent vector (zᵤ) is provided (406). For example, and as described herein, the user vector is processed through an attribute embedding look-up (e.g., the attribute embedding look-up 210 of FIG. 2), and an attention layer (e.g., the attention layer 212 of FIG. 2) to provide the user latent vector. In some examples, the user latent vector is provided as a weighted sum of each attribute value, the weights being provided as respective attention weights.

A counter q is set equal to 1 (408). An item vector is retrieved (E_{i,q}) (410). For example, a set of items (I=i₁, . . . , iₚ) can be provided for potential recommendation to the user. An example set of items can include e-learning courses (e.g., 60,000 courses of Dataset 1; p=60,000), one or more of which can be recommended to the user. In some examples, the recommender system performs an index look-up (e.g., the index look-up 205 of FIG. 2) based on an item identifier to retrieve the item vector for the particular item q. An item latent vector (z_{i,q}) is provided (412). For example, and as described herein, the item vector is processed through an attribute embedding look-up (e.g., the attribute embedding look-up 210 of FIG. 2), and an attention layer (e.g., the attention layer 212 of FIG. 2) to provide the item latent vector. In some examples, the item latent vector is provided as a weighted sum of each attribute value, the weights being provided as respective attention weights.

The user latent vector and the item latent vector are concatenated (414). For example, the latent vectors are concatenated by the concatenation 218 of FIG. 2. A score (y_{q}) is determined (416). For example, and as described herein, the concatenated vector is processed through multiple fully connected layers (e.g., the feed forward neural network 220 of FIG. 2), which extract higher order features, and learn relationships between the user, and the particular item i_{q}. In some examples, a final hidden layer is connected to an output layer with a single neuron, and a sigmoid activation function, which outputs the score. In some examples, the score represents a compatibility between the user and the particular items, and is in a range of [0,1] (e.g., the higher the score, the more compatible the item is to the user). Accordingly, the score is specific to the particular user-item pair.

It is determined whether q is equal to p (418). That is, for example, it is determined whether a score has been provided for all items in the set of items. If q is not equal to p, q is incremented (420), and the example process 400 loops back to process the next user-item pair. If q is equal to p, items are ranked based on scores (422). In some examples, items are ranked in descending order with items having higher scores ranked more highly than items having lower scores. The top X items are displayed to the user (424). For example, of the items in the set of items, the top X items are selected from the ranking for display to the user (e.g., X is an integer that is ≥1).

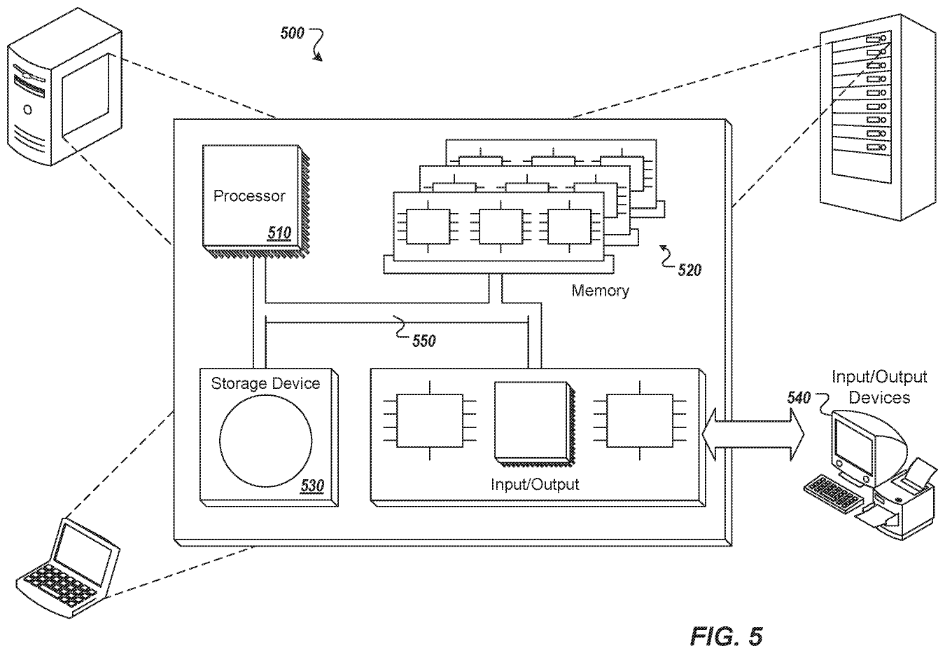

Referring now to FIG. 5, a schematic diagram of an example computing system 500 is provided. The system 500 can be used for the operations described in association with the implementations described herein. For example, the system 500 may be included in any or all of the server components discussed herein. The system 500 includes a processor 510, a memory 520, a storage device 530, and an input/output device 540. The components 510, 520, 530, 540 are interconnected using a system bus 550. The processor 510 is capable of processing instructions for execution within the system 500. In one implementation, the processor 510 is a single-threaded processor. In another implementation, the processor 510 is a multi-threaded processor. The processor 510 is capable of processing instructions stored in the memory 520 or on the storage device 530 to display graphical information for a user interface on the input/output device 540.

The memory 520 stores information within the system 500. In some implementations, the memory 520 is a computer-readable medium. In some implementations, the memory 520 is a volatile memory unit. In some implementations, the memory 520 is a non-volatile memory unit. The storage device 530 is capable of providing mass storage for the system 500. In some implementations, the storage device 530 is a computer-readable medium. In some implementations, the storage device 530 may be a floppy disk device, a hard disk device, an optical disk device, or a tape device. The input/output device 540 provides input/output operations for the system 500. In some implementations, the input/output device 540 includes a keyboard and/or pointing device. In another implementation, the input/output device 540 includes a display unit for displaying graphical user interfaces.

The features described can be implemented in digital electronic circuitry, or in computer hardware, firmware, software, or in combinations of them. The apparatus can be implemented in a computer program product tangibly embodied in an information carrier (e.g., in a machine-readable storage device, for execution by a programmable processor), and method steps can be performed by a programmable processor executing a program of instructions to perform functions of the described implementations by operating on input data and generating output. The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. Elements of a computer can include a processor for executing instructions and one or more memories for storing instructions and data. Generally, a computer can also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) monitor for displaying information to the user and a keyboard and a pointing device such as a mouse or a trackball by which the user can provide input to the computer.

The features can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, for example, a LAN, a WAN, and the computers and networks forming the Internet.

The computer system can include clients and servers. A client and server are generally remote from each other and typically interact through a network, such as the described one. The relationship of client and server arises by virtue of computer programs running on the respective computers and having a client-server relationship to each other.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

A number of implementations of the present disclosure have been described. Nevertheless, it will be understood that various modifications may be made without departing from the spirit and scope of the present disclosure. Accordingly, other implementations are within the scope of the following claims.

What is claimed is:

1. A computer-implemented method for attentive neural collaborative filtering for modeling implicit feedback, the method being executed by one or more processors and comprising:
providing, by the one or more processors, a user vector comprising a plurality of user attributes, each user attribute having a value assigned thereto, the user vector being representative of a user;
determining, by the one or more processors, a user latent vector by processing the user vector through an attribute embedding look-up, and an attention layer; and
for each item in a set of items:
providing, by the one or more processors, an item vector comprising a plurality of item attributes, each item attribute having a value assigned thereto, the item vector being specific to an item in the set of items,
determining, by the one or more processors, an item latent vector by processing the item vector through the attribute embedding look-up, and the attention layer, and
processing, by the one or more processors, the user latent vector, and the item latent vector through multiple fully connected layers to extract higher order features, and learn relationships between the user, and the item, and to provide a user-item score that represents a compatibility between the user and the item.

2. The method of claim 1, wherein processing further comprises concatenating the user latent vector, and the item latent vector.

3. The method of claim 1, further comprising caching a plurality of user latent vectors, and a plurality of item latent vectors.

4. The method of claim 1, further comprising transferring a plurality of user latent vectors, and a plurality of item latent vectors from random access memory (RAM) to video RAM (VRAM), and storing the plurality of user latent vectors, and item latent vectors as respective matrices.

5. The method of claim 1, executing a selection algorithm using a graphical processor unit (GPU) to select one or more items from the set of items to recommend to the user.

6. The method of claim 5, wherein the one or more items are selected based on respective user-item scores.

7. The method of claim 1, wherein the attention layer automatically determines weights to be applied to respective user attributes in the user vector, and item attributes in the item vector.

8. A non-transitory computer-readable storage medium coupled to one or more processors and having instructions stored thereon which, when executed by the one or more processors, cause the one or more processors to perform operations for attentive neural collaborative filtering for modeling implicit feedback, the operations comprising:
providing a user vector comprising a plurality of user attributes, each user attribute having a value assigned thereto, the user vector being representative of a user;
determining a user latent vector by processing the user vector through an attribute embedding look-up, and an attention layer; and
for each item in a set of items:
providing an item vector comprising a plurality of item attributes, each item attribute having a value assigned thereto, the item vector being specific to an item in the set of items,
determining an item latent vector by processing the item vector through the attribute embedding look-up, and the attention layer, and
processing the user latent vector, and the item latent vector through multiple fully connected layers to extract higher order features, and learn relationships between the user, and the item, and to provide a user-item score that represents a compatibility between the user and the item.

9. The computer-readable storage medium of claim 8, wherein processing further comprises concatenating the user latent vector, and the item latent vector.

10. The computer-readable storage medium of claim 8, wherein operations further comprise caching a plurality of user latent vectors, and a plurality of item latent vectors.

11. The computer-readable storage medium of claim 8, wherein operations further comprise transferring a plurality of user latent vectors, and a plurality of item latent vectors from random access memory (RAM) to video RAM (VRAM), and storing the plurality of user latent vectors, and item latent vectors as respective matrices.

12. The computer-readable storage medium of claim 8, executing a selection algorithm using a graphical processor unit (GPU) to select one or more items from the set of items to recommend to the user.

13. The computer-readable storage medium of claim 12, wherein the one or more items are selected based on respective user-item scores.

14. The computer-readable storage medium of claim 8, wherein the attention layer automatically determines weights to be applied to respective user attributes in the user vector, and item attributes in the item vector.

15. A system, comprising:
a computing device; and
a computer-readable storage device coupled to the computing device and having instructions stored thereon which, when executed by the computing device, cause the computing device to perform operations for attentive neural collaborative filtering for modeling implicit feedback, the operations comprising:
providing a user vector comprising a plurality of user attributes, each user attribute having a value assigned thereto, the user vector being representative of a user;
determining a user latent vector by processing the user vector through an attribute embedding look-up, and an attention layer; and
for each item in a set of items:
providing an item vector comprising a plurality of item attributes, each item attribute having a value assigned thereto, the item vector being specific to an item in the set of items,
determining an item latent vector by processing the item vector through the attribute embedding look-up, and the attention layer, and
processing the user latent vector, and the item latent vector through multiple fully connected layers to extract higher order features, and learn relationships between the user, and the item, and to provide a user-item score that represents a compatibility between the user and the item.

16. The system of claim 15, wherein processing further comprises concatenating the user latent vector, and the item latent vector.

17. The system of claim 15, wherein operations further comprise caching a plurality of user latent vectors, and a plurality of item latent vectors.

18. The system of claim 15, wherein operations further comprise transferring a plurality of user latent vectors, and a plurality of item latent vectors from random access memory (RAM) to video RAM (VRAM), and storing the plurality of user latent vectors, and item latent vectors as respective matrices.

19. The system of claim 15, executing a selection algorithm using a graphical processor unit (GPU) to select one or more items from the set of items to recommend to the user.

20. The system of claim 19, wherein the one or more items are selected based on respective user-item scores.
